(19) United States
(12) Patent Application Publication
(10) Pub. No.: US 2012/0036470 A1
(43) Pub. Date: Feb. 9, 2012

(54) INFORMATION PROCESSING APPARATUS, CONTROL METHOD FOR THE INFORMATION PROCESSING APPARATUS, AND RECORDING MEDIUM

(75) Inventor: Takayuki Homma, Tokyo (JP)

(73) Assignee: CANON KABUSHIKI KAISHA, Tokyo (JP)

(21) Appl. No.: 13/187,680

(22) Filed: Jul. 21, 2011

(30) Foreign Application Priority Data
Aug. 9, 2010 (JP) 2010-179002

(51) Int. Cl. G06F 3/048

(52) U.S. Cl. 715/777

(57) ABSTRACT

An information processing apparatus according to the present invention includes a tab browser that can hold a plurality of pieces of screen information provided by a Web server in different windows and that can switch any of the windows into an active state by a user selecting a tab relating to that window. In the information processing apparatus, a determination unit, if a request for screen information from the user is accepted, determines whether there is any window that is not active among the windows held by the tab browser. If it is determined that a window that is not active exists among the windows held by the tab browser, a control unit closes the window that is not active. After the window that is not active was closed, a request unit requests the screen information requested by the user from the Web server.

### BACKGROUND OF THE INVENTION

1. Field of the Invention

The present invention relates to an information processing apparatus including a Web browser that displays an operation screen provided by a Web server, a control method for the information processing apparatus, and a recording medium.

2. Description of the Related Art

A technique is known by which an information processing apparatus such as a PC connected to a Web server via a network such as a LAN includes a Web browser and displays a screen provided by a Web application on the Web server in a display unit with the Web browser. In such an information processing apparatus, first, the Web browser transmits a request for an operation screen to the Web server. Next, the Web application on the Web server that has received the request from the information processing apparatus executes a process for generating HTML data corresponding to the requested operation screen and transmits the generated HTML data to the information processing apparatus as a response to the request. Then, the Web browser of the information processing apparatus analyzes the received HTML data and displays a screen based on the descriptions of the received HTML data in the display unit.

Recently, some Multi Function Peripherals (MFPs) including a scanner, a printer and so forth have also included a Web browser. For example, according to Japanese Patent Laid-Open No. 2006-127503, a Web server provides an operation screen for using the functions of an MFP. In this case, the user of the MFP inputs an instruction to the MFP via the operation screen displayed by the Web browser in a display unit. Then, the input instruction is notified to the Web server by the Web browser of the MFP. Upon receipt of the notification, the Web server requests the MFP to execute various processes in accordance with the details of the instruction input by the user. The MFP executes the processes requested by the Web server. This eliminates the need to hold all the menu data for operating the MFP within the MFP and also enables any change to the menu data to be made easily on the Web server.

In addition, Japanese Patent Laid-Open No. 2008-107865 discloses a technique for efficiently displaying, in an apparatus including a display unit with a small display region, a screen based on HTML data in the display region. According to this patent document, a screen based on HTML data can be efficiently displayed even in an apparatus having a small display region, such as an MFP, by utilizing a tab browser, which is a type of Web browser.

However, a commonly used tab browser does not manage session information relating to sessions established with the Web application for each displayed window. For this reason, when the same screen information as screen information newly requested by the user is being already held by the tab browser in any of the windows, there is the possibility that the session information of the session that has already been established with the Web application may be overwritten with the session information corresponding to the screen information newly requested by the user. Accordingly, session information that is different from the session information that has already been used is used to make an access for requesting the same screen information to the Web application, resulting in the possibility that an access from the tab browser may be regarded by the Web application as an unauthorized access. In this case, the tab browser and the Web application may not be able to communicate normally with each other.

### SUMMARY OF THE INVENTION

The present invention has been achieved in view of the foregoing problems and prevents operational failure of a tab browser and a Web application in the case where the same screen information as screen information that is already being held by the tab browser is requested by the user.

According to one aspect of the present invention, there is provided an information processing apparatus comprising a tab browser that can hold a plurality of pieces of screen information provided by a Web server in different windows and that can switch any of the windows into an active state by a user selecting a tab relating to that window, the apparatus comprising: a determination unit that, if a request for screen information from the user is accepted, determines whether there is any window that is not active among the windows held by the tab browser; a control unit that, if it is determined by the determination unit that a window that is not active exists among the windows held by the tab browser, closes the window that is not active; and a request unit that, after the window that is not active was closed by the control unit, requests the screen information requested by the user from the Web server.

According to another aspect of the present invention, there is provided an information processing apparatus comprising a tab browser that can hold a plurality of pieces of screen information provided by a Web server in different windows and that can switch any of the windows into an active state by a user selecting a tab relating to that window, the apparatus comprising: a determination unit that, if a request for screen information from the user is accepted, determines whether the same screen information as the requested screen information is already being held by the tab browser in any of the windows; and a request unit that, if it is determined by the determination unit that the same screen information as the requested screen information is not yet being held by the tab browser, requests the requested screen information from the Web server.

According to still another aspect of the present invention, there is provided a control method for an information processing apparatus comprising a tab browser that can hold a plurality of pieces of screen information provided by a Web server in different windows and that can switch any of the windows into an active state by a user selecting a tab relating to that window, the method comprising: determining, if a request for screen information from the user is accepted, whether there is any window that is not active among the windows held by the tab browser; performing a control, if it is determined in the determining step that a window that is not active exists among the windows held by the tab browser, so as to close the window that is not active; and requesting, after the window that is not active was closed in the control step, the screen information requested by the user from the Web server.

According to yet another aspect of the present invention, there is provided a control method for an information processing apparatus comprising a tab browser that can hold a plurality of pieces of screen information provided by a Web server in different windows and that can switch any of the windows into an active state by a user selecting a tab relating to that window, the method comprising: determining, if a request for screen information from the user is accepted, whether the same screen information as the requested screen information is already being held by the tab browser in any of the windows; and requesting, if it is determined in the determining step that the same screen information as the requested screen information is not yet being held by the tab browser, the requested screen information from the Web server.

According to still yet another aspect of the present invention, there is provided a computer-readable recording medium storing a program for causing a computer to, in an information processing apparatus comprising a tab browser that can hold a plurality of pieces of screen information provided by a Web server in different windows and that can switch any of the windows into an active state by a user selecting a tab relating to that window, function as: a determination unit that, if a request for screen information from the user is accepted, determines whether there is any window that is not active among the windows held by the tab browser; a control unit that, if it is determined by the determination unit that a window that is not active exists among the windows held by the tab browser, closes the window that is not active; and a request unit that, after the window that is not active was closed by the control unit, requests the screen information requested by the user from the Web server.

According to yet still another aspect of the present invention, there is provided a computer-readable recording medium storing a program for causing a computer to, in an information processing apparatus comprising a tab browser that can hold a plurality of pieces of screen information provided by a Web server in different windows and that can switch any of the windows into an active state by a user selecting a tab relating to that window, function as: a determination unit that, if a request for screen information from the user is accepted, determines whether the same screen information as the requested screen information is already being held by the tab browser in any of the windows; and a request unit that, if it is determined by the determination unit that the same screen information as the requested screen information is not yet being held by the tab browser, requests the requested screen information from the Web server.

According to the present invention, it is possible to prevent operational failure of a tab browser and a Web application when the same screen information as screen information that is already being held by the tab browser is requested by the user.

Further features of the present invention will become apparent from the following description of exemplary embodiments (with reference to the attached drawings).

### BRIEF DESCRIPTION OF THE DRAWINGS

FIG. 1 is a diagram showing an overall configuration of an information processing system according to a first embodiment of the present invention.

FIGS. 2A and 2B are diagrams showing hardware configurations of an MFP and a Web server, respectively.

FIG. 3 is a diagram showing the detailed configuration of an operation unit of the MFP.

FIGS. 4A and 4B are diagrams showing software configurations of the MFP and the Web server, respectively.

FIGS. 5A and 5B show a screen information table and a hard key/URL correspondence table, respectively.

FIGS. 6A, 6B and 6C show a top menu screen and an FTP transmission screen.

FIG. 7 is a flowchart illustrating a processing procedure of a screen display control process.

FIG. 8 is a flowchart illustrating a processing procedure of a screen display control process according to a second embodiment of the present invention.

### DESCRIPTION OF THE EMBODIMENTS

Hereinafter, embodiments of the present invention will be described in detail with reference to the accompanying drawings. It should be noted that the following embodiments are not intended to limit the scope of the claims and not all of the combinations of the features described in the embodiments are necessarily essential to the solving means of the present invention.

### First Embodiment

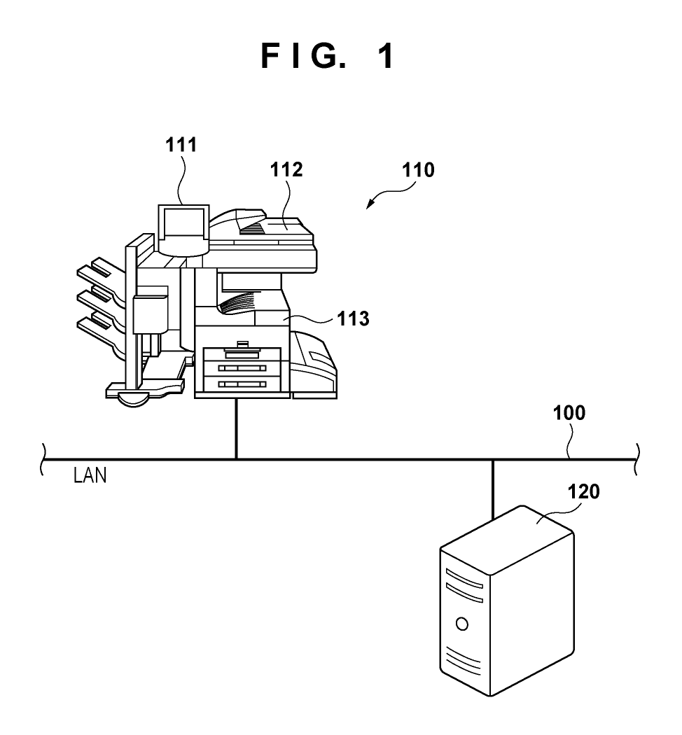

In this embodiment, an MFP, which is an example of an information processing apparatus of the present invention, forcefully closes an inactive window when it detects a depression of a hard key and transmits a screen request to the URL corresponding to the hard key for which a depression has been detected. When requesting any screen to be respectively displayed in a plurality of windows from a Web application of a Web server, this inactive window closing process prevents an access by means of a session established between the MFP and the Web application from being regarded as an unauthorized access as a result of requesting the same screen from the same Web application for each window.

<Overall Configuration of Information Processing System (FIG. 1)>

An information processing system of the present embodiment includes an MFP 110 and a Web server 120. The MFP 110 and the Web server 120 are each connected to a LAN 100 composed of Ethernet (registered trademark) or the like. The MFP 110 includes a tab browser capable of holding a plurality of pieces of screen information provided by the Web server 120 in different windows and capable of selectively displaying any of the windows by the user selecting a tab relating to that window. Further, the MFP 110 has a copy function, a file transfer function and an e-mail function. The file transfer function reads a document image and transfers image data (also referred to as “document data”) obtained by reading the image to a designated apparatus on the LAN 100 using FTP (File Transfer Protocol), the SMB (Server Message Block) protocol or the like. The e-mail function creates an e-mail containing the image as an attached file and transmits the e-mail by using an e-mail server (not shown).

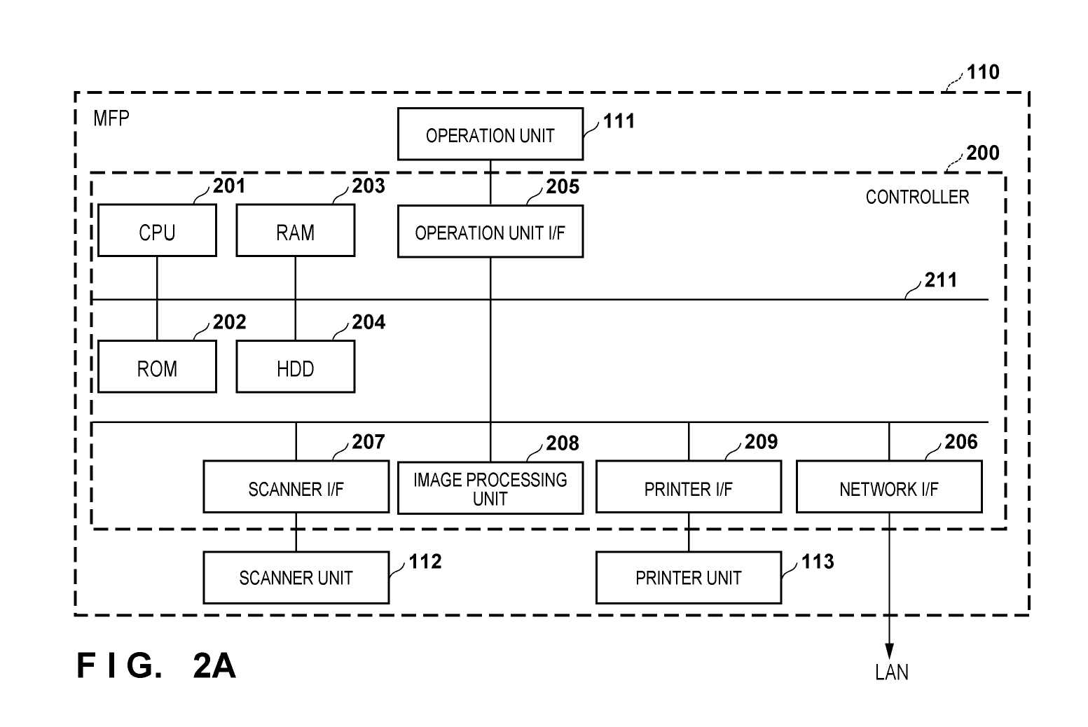

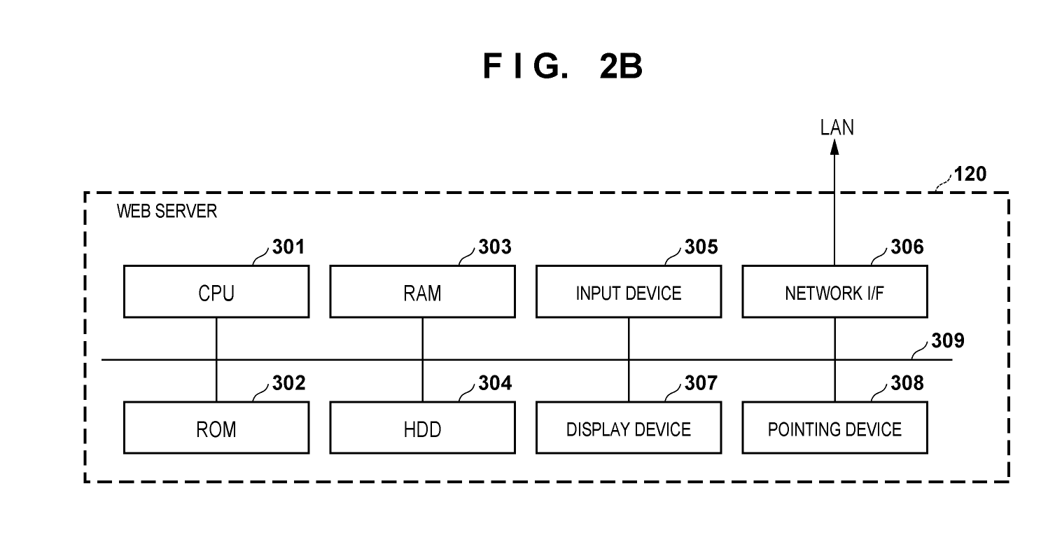

The Web server 120 includes a Web application, which is software that runs on the Web server. In response to a request from the MFP 110, the Web application transmits the HTML page corresponding to screen information for displaying a screen in an operation unit (display unit) of the MFP 110, to the MFP 110 as a response to that request. However, the number of these components of the information processing system according to this embodiment is not limited to the number of the components shown in FIG. 1. Although LAN is used as the method for connecting these components in this embodiment, the present invention is not limited thereto. For example, it is possible to use any network equivalent to a public network, such as Wide Area Network (WAN), a serial transmission scheme such as USB, or a parallel transmission scheme such as Centronics or SCSI.

<Hardware Configuration of MFP 110 (FIG. 2A)>

The MFP 110 includes a scanner unit 112 serving as a device to input images, a printer unit 113 serving as a device to output images, a controller 200 that provides overall control for the MFP 110, and an operation unit 111 that accepts input operations performed by the user.

The scanner unit 112 inputs, into a CCD, reflected light obtained through exposure and scanning of an image on a document, thus converting the information about the image into an electric signal. Further, the scanner unit 112 converts the electric signal into a luminance signal composed of R, G and B and outputs the luminance signal to the controller 200 in the form of digital image data. Note that when the user gives an instruction through the operation unit 111 to start reading, with a document set in a document feeder, the controller 200 gives an instruction to the scanner unit 112 to read the document. Upon receipt of the instruction, the scanner unit 112 reads the document while feeding sheets of the document one by one from the document feeder. Note that the method for reading the document may be a method in which the document scan is performed by moving an exposure unit along a glass surface (not shown) with a document placed on the glass surface, instead of automating feeding using a document feeder.

The printer unit 113 forms an image on a sheet based on the image data received from the controller 200. Note that although an electrophotographic method using a photosensitive drum and a photosensitive belt is used as the image formation method in this embodiment, the present invention is not limited thereto. For example, it is possible to use an inkjet method in which ink is discharged onto a sheet from an array of minute nozzles to form an image on the sheet.

The controller 200 is electrically connected to the operation unit 111, the scanner unit 112 and the printer unit 113 via an operation unit interface (I/F) 205, a scanner I/F 207 and a printer I/F 209, respectively, and is connected to the LAN 100 via a network I/F 206. That is, the controller 200 is connected to other devices via the LAN 100. This enables the controller 200 to communicate with the other devices with the HTTP protocol.

A CPU 201 provides overall control for accesses to various connected MFPs and accesses from other MFPs, in accordance with a control program or the like stored in a ROM 202. In addition, the CPU 201 also provides overall control for various processes performed within the controller 200. This control includes execution of a program for implementing a flowchart described below. The ROM 202 stores a boot program of the apparatus. A RAM 203 functions as a system work memory for the CPU 201 to operate and also as a memory for temporarily storing image data. The RAM 203 includes an area that keeps holding the stored content, for example, by backup power after the power-off of the apparatus and an area in which the stored content is erased after the power-off. A hard disc drive (HDD) 204 can store system software and image data.

The operation unit I/F 205 is an interface for connecting a system bus 211 and the operation unit 111. The operation unit I/F 205 receives image data for being displayed in the operation unit 111 from the system bus 211, outputs the image data to the operation unit 111, and outputs the information input from the operation unit 111 to the system bus 211. The network I/F 206 is connected to the LAN 100 and the system bus 211, and enables input/output of information between the LAN 100 and the system bus 211. The scanner I/F 207 corrects, processes and edits the image data received from the scanner unit 112. Note that the scanner I/F 207 has the function of determining whether the received image data is based on, for example, a color document, a black and white document, a text document, or a picture document.

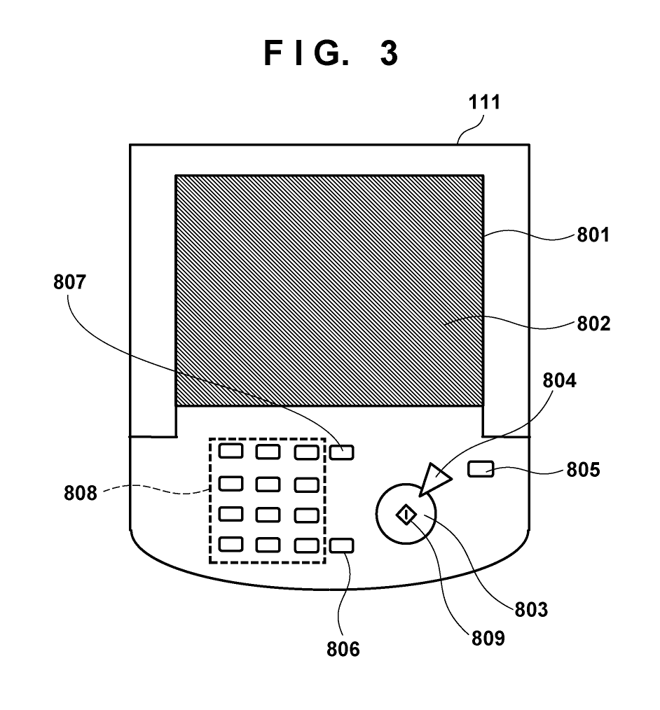

An image processing unit 208 executes image processing such as changing orientation of image data and an image compression/decompression process. Further, the image processing unit 208 can generate a single image by combining a plurality of images saved in the HDD 204. The printer I/F 209 receives the image data sent from the image processing unit 208 and performs image processing on the image data with reference to the attribute data added to the image data. The image processing unit 208 outputs the image data that has been subjected to the image processing to the printer unit 113.

[Configuration of Operation Unit (FIG. 3)]

The operation unit 111 includes an LCD display unit 801 made up of an LCD and a touch panel sheet 802 attached on the LCD. An operation screen and soft keys are displayed in the LCD display unit 801 by a tab browser described below. When any of the keys displayed in the LCD display unit 801 is depressed by the user via the touch panel sheet 802, the position information indicating the depressed position is passed from the operation unit 111 to the CPU 201.

The operation unit 111 is also provided with various hard keys such as a start key 803, a stop key 804, a reset key 805, a guide key 806, a top menu key 807 and a numeric keypad 808. The start key 803 is a key for providing an instruction to start the operation of reading a document image, and a two-color LED display unit 809 including green and red LEDs is provided at the center of the start key 803. The two-color LED display unit 809 indicates whether or not the start key 803 is operable by means of the colors of the LEDs. The stop key 804 is a key for stopping any currently running operation. The reset key 805 is a key for initializing the settings. The guide key 806 is a key for displaying the method for using the MFP 110 in the form of a guide. The top menu key 807 is a key for displaying a top menu screen that allows selection of the functions of the MFP 110. The numeric keypad 808 is a keypad for inputting numeric values. Note that although the MFP 110 is a network MFP that performs the UI display in this embodiment, the MFP 110 may be an information processing apparatus to which a general-purpose scanner, a general-purpose printer and the like are connected, such as a general-purpose computer.

<Hardware Configuration of Web Server (FIG. 2B)>

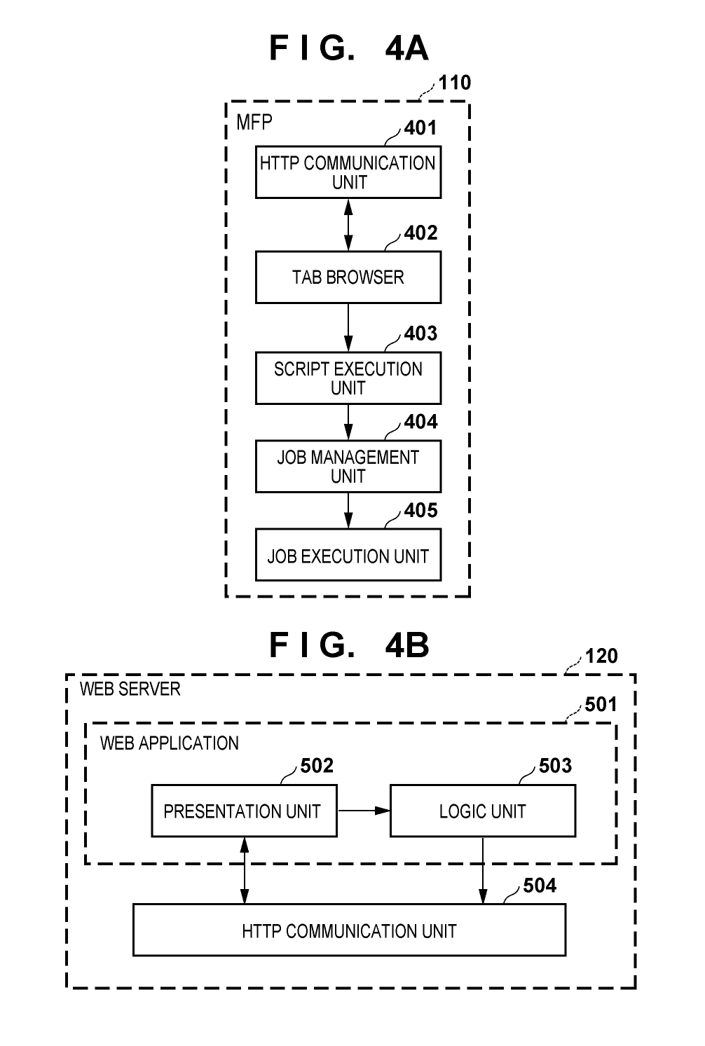

The Web server 120 includes a CPU 301, a ROM 302, a RAM 303, an HDD 304, an input device 305 such as a keyboard, a network I/F 306, a display device 307 such as a CRT, and a pointing device 308 such as a mouse. These components are connected in such a manner that they can communicate with each other via a system bus 309. The HDD 304 or the ROM 302 stores a control program such as an operating system or a Web application. The CPU 301 fulfills the function of a computer by reading the control program from the HDD 304 onto the RAM 303 as needed and executing the program. The CPU 301 displays various kinds of information via the display device 307 and accepts inputs such as a user instruction through the input device 305 and the pointing device 308. Further, the CPU 301 communicates with the other devices on the LAN 100 via the network I/F 306.

<Software Configuration of MFP 110 (FIG. 4A)>

A software module of the MFP 110 is stored in the HDD 204 of the MFP 110. The CPU 201 reads the software module from the HDD 204 onto the RAM 203 as needed and executes the module. An HTTP communication unit 401 is a module that performs communication using the HTTP protocol by operating the network I/F 206. A tab browser 402 communicates with the Web server 120 via the HTTP communication unit 401. The tab browser 402 requests screen information about an operation screen described in HTML from the Web server 120 via the HTTP communication unit 401. Next, the tab browser 402 renders the HTML data about the operation screen (screen information) received from the Web server 120 via the HTTP communication unit 401 and displays the resulting data in the operation unit 111. When information is input to the operation screen displayed in the operation unit 111, the tab browser 402 notifies the Web server 120 of the information input from the operation unit 111.

A script execution unit 403 parses a script that has been transmitted from the Web server 120 and has been received via the tab browser 402, and divides the information contained in the script into pieces of job information. Then, the script execution unit 403 gives a notification to a job management unit 404 so as to execute the pieces of job information in the order specified in the script. The job management unit 404 manages the job information in response to an instruction from the script execution unit 403 and instructs a job execution unit 405 to sequentially execute the jobs. The job execution unit 405 is a module that executes processes in accordance with the job information. For example, when a job to be executed is a scan job, the job execution unit 405 reads a paper document by operating the scanner unit 112 and saves the resulting image data in the HDD 204. When a job to be executed is a transmission job, job execution unit 405 transmits the image data contained in the HDD 204 by operating the network I/F 206.

<Software Configuration of Web Server 120 (FIG. 4B)>

The Web server 120 includes a Web application 501 and an HTTP communication unit 504 as software modules. The Web application 501 contains a presentation unit 502 and a logic unit 503. These software modules are stored in the HDD 304 of the Web server 120, and the CPU 301 reads the software modules from the HDD 304 onto the RAM 303 as needed and executes the modules.

In response to a request from the MFP 110, the presentation unit 502 transmits, to the MFP 110 via the HTTP communication unit 504, the screen information about the operation screen to be displayed in the operation unit 111 by the tab browser 402 of the MFP 110 as a response to the request. Further, the presentation unit 502 receives, from the MFP 110 via the HTTP communication unit 504, the input information from the user that has been input via the operation screen displayed in the operation unit 111 by the tab browser 402 of the MFP 110.

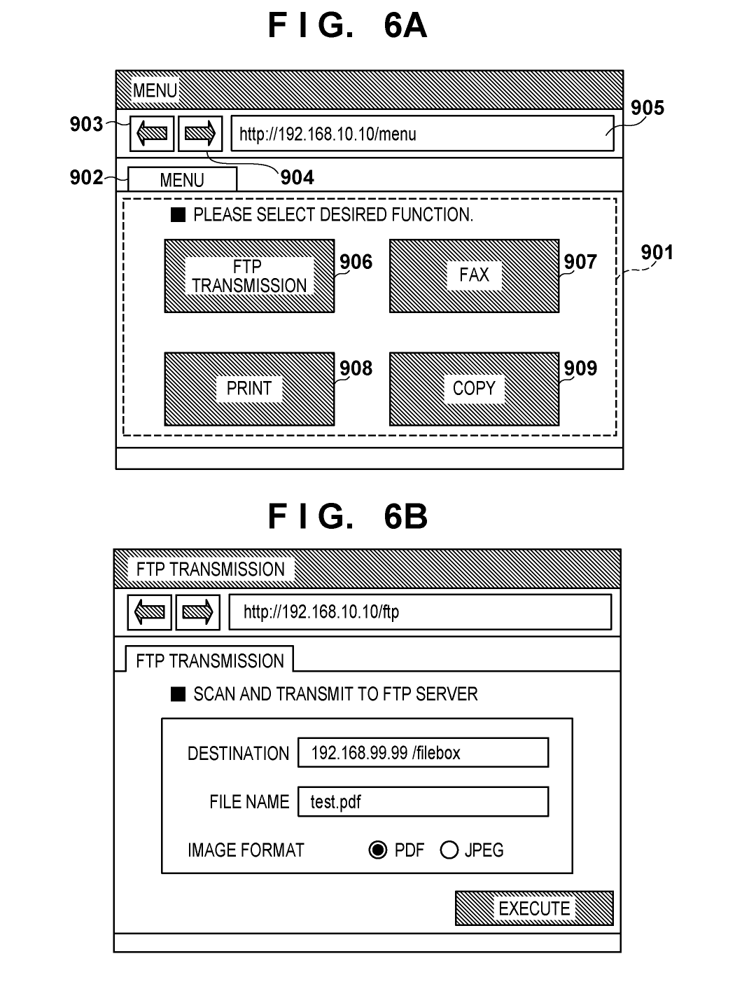

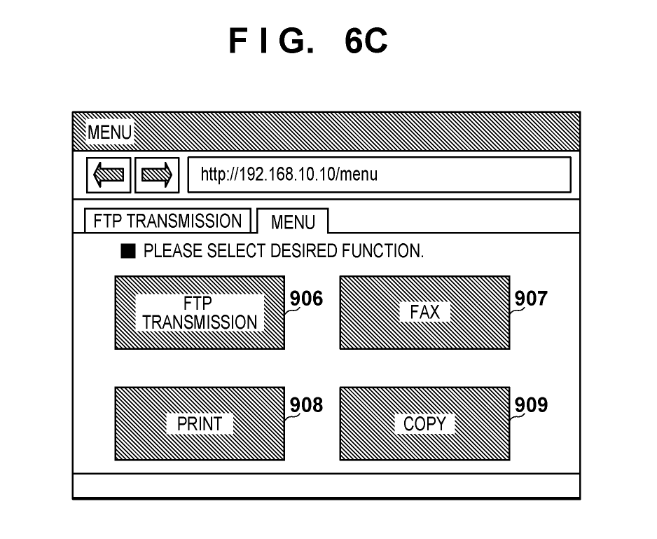

The logic unit 503 performs processes in accordance with the input information from the MFP 110 that has been passed from the presentation unit 502. For example, the logic unit 503 modifies the screen to be displayed and generates job definition information (script) for performing the device functionality of the MFP 110, according to the input from the user. The HTTP communication unit 504 is a module that performs communication using the HTTP protocol by operating the network I/F 306.

<MFP Operation Screen Display (FIGS. 6A to 6C)>

The tab browser 402 displays the operation screen shown in FIG. 6A in the operation unit 111. A window 901 displays a screen based on HTML data that has been received from the Web application 501 and displays an operation screen through which the user operates the MFP 110 in this embodiment. A tab 902 is used to switch the window to be displayed and is provided for each window.

The tab browser 402 can hold a plurality of windows to respectively display a plurality of pieces of screen information. When the tab browser 402 holds a plurality of windows, the user can switch the display of the windows by using (selecting) the tab existing for each window. Here, of the windows held by the tab browser 402, the window displayed in the foreground is referred to as an “active” window and any window that is not displayed in the foreground (displayed behind the foreground window) is referred to as an “inactive” window.

A back button 903 is a button for returning, in the current active window, the display to the screen that was displayed immediately before the current screen. A forward button 904 is a button for returning, in the case where the displayed screen has been changed with the back button 903, the display to the previous screen again. An address field 905 displays the URL (storage address) indicating the location of the screen information of the currently displayed screen. Further, the tab browser 402 can also change the screen display by making an HTTP request to an URL that has been directly input into the address field 905.

GUI buttons 906 to 909 are links to the Web application 501 that correspond to their respective functions. For example, when the tab browser 402 detects a depression of the GUI button 906 (FTP transmission), it transmits an HTTP request to the URL (http://192.168.10.10/ftp), which is registered as the link. Additionally, the tab browser 402 displays the FTP transmission screen shown in FIG. 6B in the operation unit 111, based on the HTML data received as a response to the HTTP request.

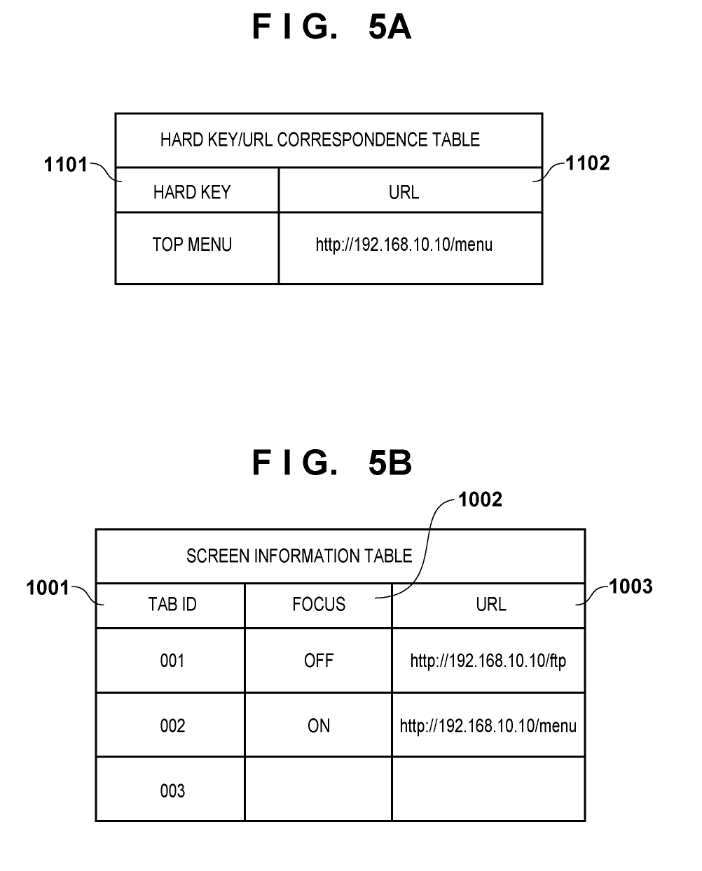

Further, when the tab browser 402 detects a depression of a hard key such as the top menu key 807, it refers to the hard key/URL correspondence table shown in FIG. 5A and makes an HTTP request to the URL corresponding to the hard key for which a depression has been detected. Accordingly, the tab browser 402 can also display the screen corresponding to each hard key. In general, the functions corresponding to the buttons 903 to 905 are independent from the screens displayed in the window 901, and the user can operate these buttons anytime.

FIG. 5B shows a screen information table managed by the tab browser 402. Using this screen information table, the tab browser 402 manages a URL 1003 corresponding to the screen information held by each window (tab ID 1001) in association with a focus 1002, which is display information indicating whether each window (tab ID 1001) is active. The tab ID 1001 is information uniquely identifying the tab and represents a tab with which a window is displayed.

The focus 1002 is information indicating the display state of the window of the tab identified by the tab ID 1001. “ON” is recorded in the focus 1002 if the screen information corresponding to the URL 1003 is displayed in the foreground and thus the window is active and can accept an input operation from the user. “OFF” is recorded in the focus 1002 if the above-mentioned screen information is displayed in the background and thus the window is inactive and does not accept an input operation from the user.

The URL 1003 indicates the location of the HTML data (screen information) displayed in the window of the tab identified by the tab ID 1001 and a control script to be processed in the MFP 110. The tab browser 402 adds, updates and deletes the screen information according to the addition of a window, the update of the display screen information and the deletion of a window.

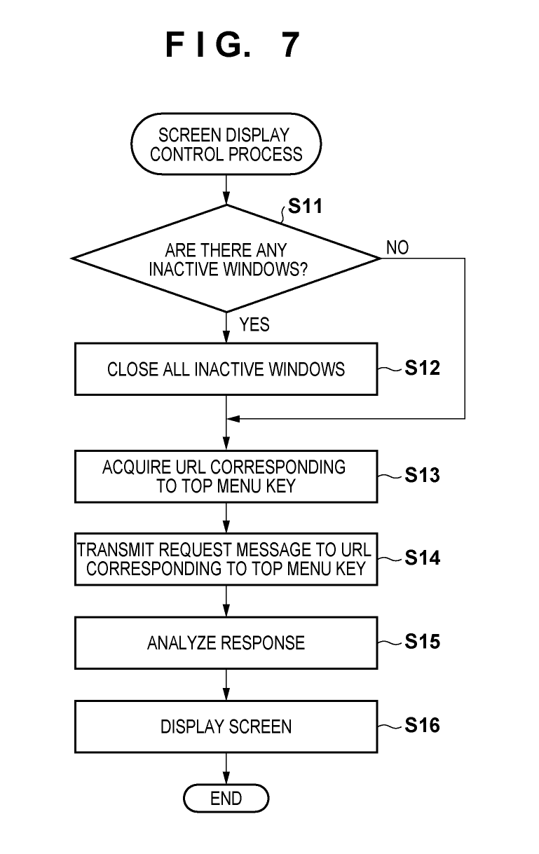

FIG. 6C is a diagram showing the display state of the tab browser 402, corresponding to the state of the image information table shown in FIG. 5B. FIG. 5A shows the hard key/URL correspondence table managed by the tab browser 402. Using the hard key/URL correspondence table, the tab browser 402 manages the URL indicating the location of a requested screen upon detection of a depression of each hard key. The information about the screen corresponding to each hard key is registered in a hard key 1101. The URL information that is used to request the corresponding screen upon detection of a depression of each hard key and that indicates the location of that screen is registered in a URL 1102.

<Screen Display Control Process (FIG. 7)>

A process by which the tab browser 402 displays the top menu screen upon detection of a user depression of the top menu key 807 will now be described as an example. First, the tab browser 402 refers to the column of the focus 1002 in the screen information table shown in FIG. 5B and determines whether there are any inactive windows among the windows held by the tab browser 402 (S11). If there are any inactive windows, the tab browser 402 automatically closes all the inactive windows (S12). If, on the other hand, there is no inactive window, the tab browser 402 omits the process of S12 and moves to the process of S13.

Next, the tab browser 402 refers to the hard key/URL correspondence table shown in FIG. 5A and acquires from the table the URL corresponding to the top menu screen information that is displayed when a depression of the top menu key 807 is detected (S13). Then, the tab browser 402 transmits a request message to the URL acquired in S13, which corresponds to the top menu key 807 to the URL acquired in S13 (S14). Upon reception of a response message to this request message, the tab browser 402 analyzes the received response message and acquires the HTML data (S15). Finally, the tab browser 402 displays the screen based on the HTML data acquired in S15 in the active window (S16).

As described above, according to this embodiment, in the case of requesting any of screens to be respectively displayed in a plurality of windows held by the tab browser of an MFP, it is possible to prevent an access by means of a session established between the MFP and a Web application from being regarded as an unauthorized access as a result of requesting the screen corresponding to the same URL from the same Web application. Consequently, it is also possible to prevent operational failure of the tab browser of the MFP and the Web application.

### Second Embodiment

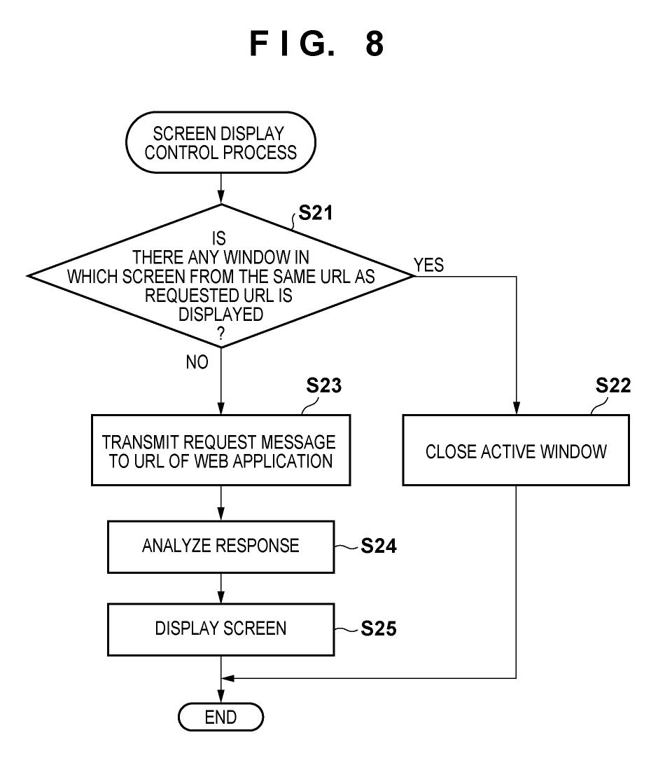

In this embodiment, in the case of requesting a screen to be displayed in an active window, the tab browser of an MFP controls the screen display based on the URL information corresponding to that screen. Specifically, in the case of requesting any of screens to be respectively displayed in a plurality of windows from a Web application, the tab browser prevents, based on the URL information corresponding to the requested screen, an access by means of a session established between the MFP and the Web application from being regarded as an unauthorized access as a result of requesting the screen corresponding to the same URL from the same Web application for each window. The second embodiment is different from the first embodiment only with respect to the flow of the window control process.

<Screen Display Control Process (FIG. 8)>

A description will now be given of the process executed for displaying the operation screen of the functions of the MFP 110 after detection of a user depression of the GUI buttons 906 to 909 of the top menu screen displayed in the window of the tab browser 402 shown in FIG. 6A. First, the tab browser 402 refers to the screen information table shown in FIG. 5B and determines whether there is any window in which a screen received from the same URL as the URL of the requested operation screen is already being displayed (S21). If there is any such window, the tab browser 402 closes the active window displaying the top menu screen (S22), thus finishing the series of processes. If, on the other hand, there is no such window, the tab browser 402 transmits a request message to the URL of the MFP operation screen (S23). Upon receipt of a response message to the request message, the tab browser 402 analyzes the received response message and acquires HTML data (S24). Finally, the tab browser 402 displays the screen based on the HTML data acquired in S24 in the active window (S25).

As described above, according to this embodiment, in the case of requesting any of screens to be respectively displayed in a plurality of windows held by the tab browser of an MFP, it is possible to prevent an access based on session information being used from being regarded as an unauthorized access as a result of requesting the screen corresponding to the same URL from the same Web application, without compromising the advantages of the tab browser of the MFP. Consequently, it is also possible to prevent operational failure of the tab browser of the MFP and the Web application.

### Other Embodiments

Aspects of the present invention can also be realized by a computer of a system or apparatus (or devices such as a CPU or MPU) that reads out and executes a program recorded on a memory device to perform the functions of the above-described embodiment(S), and by a method, the steps of which are performed by a computer of a system or apparatus by, for example, reading out and executing a program recorded on a memory device to perform the functions of the above-described embodiment(S). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-179002, filed Aug. 9, 2010, which is hereby incorporated by reference herein in its entirety.

What is claimed is:

1. An information processing apparatus comprising a tab browser that can hold a plurality of pieces of screen information provided by a Web server in different windows and that can switch any of the windows into an active state by a user selecting a tab relating to that window, the apparatus comprising:
a determination unit that, if a request for screen information from the user is accepted, determines whether there is any window that is not active among the windows held by the tab browser;
a control unit that, if it is determined by the determination unit that a window that is not active exists among the windows held by the tab browser, closes the window that is not active; and
a request unit that, after the window that is not active was closed by the control unit, requests the screen information requested by the user from the Web server.

2. The information processing apparatus according to claim 1 further comprising a management unit that manages display information indicating whether each of the windows held by the tab browser is active,
wherein the determination unit determines whether there is any window that is not active among the windows held by the tab browser, based on the display information managed by the management unit.

3. The information processing apparatus according to claim 2, wherein the management unit manages the display information in association with a storage address indicating the location of the screen information held in each of the windows contained in the display information.

4. An information processing apparatus comprising a tab browser that can hold a plurality of pieces of screen information provided by a Web server in different windows and that can switch any of the windows into an active state by a user selecting a tab relating to that window, the apparatus comprising:
a determination unit that, if a request for screen information from the user is accepted, determines whether the same screen information as the requested screen information is already being held by the tab browser in any of the windows; and
a request unit that, if it is determined by the determination unit that the same screen information as the requested screen information is not yet being held by the tab browser, requests the requested screen information from the Web server.

5. The information processing apparatus according to claim 4 further comprising a management unit that manages a storage address indicating the location of the screen information held in each of the windows held by the tab browser,
wherein the determination unit determines whether the same screen information as the requested screen information is already being held by the tab browser, based on the storage addresses managed by the management unit.

6. The information processing apparatus according to claim 5, wherein the management unit manages each of the storage addresses in association with display information indicating whether the window corresponding to that storage address is active.

7. A control method for an information processing apparatus comprising a tab browser that can hold a plurality of pieces of screen information provided by a Web server in different windows and that can switch any of the windows into an active state by a user selecting a tab relating to that window, the method comprising:
determining, if a request for screen information from the user is accepted, whether there is any window that is not active among the windows held by the tab browser;
performing a control, if it is determined in the determining step that a window that is not active exists among the windows held by the tab browser, so as to close the window that is not active; and
requesting, after the window that is not active was closed in the control step, the screen information requested by the user from the Web server.

8. A control method for an information processing apparatus comprising a tab browser that can hold a plurality of pieces of screen information provided by a Web server in different windows and that can switch any of the windows into an active state by a user selecting a tab relating to that window, the method comprising:
determining, if a request for screen information from the user is accepted, whether the same screen information as the requested screen information is already being held by the tab browser in any of the windows; and
requesting, if it is determined in the determining step that the same screen information as the requested screen information is not yet being held by the tab browser, the requested screen information from the Web server.

9. A computer-readable recording medium storing a program for causing a computer to, in an information processing apparatus comprising a tab browser that can hold a plurality of pieces of screen information provided by a Web server in different windows and that can switch any of the windows into an active state by a user selecting a tab relating to that window, function as:
a determination unit that, if a request for screen information from the user is accepted, determines whether there is any window that is not active among the windows held by the tab browser;
a control unit that, if it is determined by the determination unit that a window that is not active exists among the windows held by the tab browser, closes the window that is not active; and
a request unit that, after the window that is not active was closed by the control unit, requests the screen information requested by the user from the Web server.

10. A computer-readable recording medium storing a program for causing a computer to, in an information processing apparatus comprising a tab browser that can hold a plurality of pieces of screen information provided by a Web server in different windows and that can switch any of the windows into an active state by a user selecting a tab relating to that window, function as:
a determination unit that, if a request for screen information from the user is accepted, determines whether the same screen information as the requested screen information is already being held by the tab browser in any of the windows; and
a request unit that, if it is determined by the determination unit that the same screen information as the requested screen information is not yet being held by the tab browser, requests the requested screen information from the Web server.
